(19) United States
(12) Patent Application Publication
(10) Pub. No.: US 2021/0031914 A1
(43) Pub. Date: Feb. 4, 2021

(54) POWER APPARATUS AND UNMANNED HELICOPTER

(71) Applicant: TIANJIN AURORA UNMANNED AEAIL SYSTEMS TECHNOLOGY CO., LTD., Tianjin (CN)

(72) Inventor: Shuguang Zhao, Tianjin (CN)

(21) Appl. No.: 16/968,034

(22) PCT Filed: Feb. 2, 2019
(86) PCT No.: PCT/CN2019/074596

§ 371 Date: Aug. 6, 2020

(30) Foreign Application Priority Data
Feb. 8, 2018 (CN) 201810127107.0

(51) Int. Cl. B64C 39/02; B64D 27/02; B64D 27/26; B64C 27/14; F16H 37/06

(52) U.S. Cl. CPC B64C 39/024; B64D 27/02; B64D 27/26; B64C 27/14; F16H 2702/00; B64D 2027/262; B64C 2201/024; B64C 2201/044; F16H 37/06

(57) ABSTRACT

A power apparatus including: a first engine (13) and a second engine (14) symmetrically arranged side by side; a first rotating shaft (21) connected to an output end of the first engine; a second rotating shaft (22) connected to an output end of the second engine; and a speed reducer (3) connected to the first rotating shaft and the second rotating shaft, where a side face of the first engine facing away from the second engine and a side face of the second engine facing away from the first engine are each provided with an exhaust port. Further provided is an unmanned helicopter including the power apparatus.

The present application claims to the priority of Chinese patent application No. 201810127107.0 filed on Feb. 8, 2018, disclosure of which is incorporated herein by reference in its entirety.

### TECHNICAL FIELD

The present disclosure relates to the technical field of unmanned aerial vehicles, for example, to a power apparatus and an unmanned helicopter.

### BACKGROUND

In the related art, a medium or large unmanned helicopter is generally driven by a single-engine piston engine. However, a piston engine has a large volume and large weight, and produces significant vibration and noise during operation. Furthermore, a special cooling system needs to be equipped to ensure a long-term stable operation. In addition, the single engine design requires the engine has a particularly strong reliability, and once the engine fails, the unmanned helicopter would not be able to be used, even an accident may occur.

### SUMMARY

The present disclosure provides a power apparatus and an unmanned helicopter. The power apparatus is driven by two engines, and in the event that one of the two engines is damaged, the power apparatus can be driven by the other engine, thus avoiding damage to the unmanned helicopter.

One embodiment provides a power apparatus including: a first engine and a second engine symmetrically arranged side by side; a first rotating shaft connected to an output end of the first engine; a second rotating shaft connected to an output end of the second engine; and a speed reducer connected to the first rotating shaft and the second rotating shaft, where a side face of the first engine facing away from the second engine and a side face of the second engine facing away from the first engine are each provided with an exhaust port.

One embodiment provides an unmanned helicopter including the above-mentioned power apparatus.

### BRIEF DESCRIPTION OF DRAWINGS

FIG. 1 is a front view of a power apparatus according to a first embodiment of the present disclosure.

FIG. 2 is a top view of a power apparatus according to the first embodiment of the present disclosure.

FIG. 3 is a cross-sectional view of a power apparatus where a speed reducer is not connected according to the first embodiment of the present disclosure.

FIG. 4 is a front view of a power apparatus according to a second embodiment of the present disclosure.

FIG. 5 is a top view of a power apparatus according to the second embodiment of the present disclosure.

FIG. 6 is a cross-sectional view of a first engine of a power apparatus where a speed reducer is not connected according to the second embodiment of the present disclosure.

FIG. 7 is a cross-sectional view of a second engine of a power apparatus where a speed reducer is not connected according to the second embodiment of the present disclosure.

### LIST OF REFERENCE SIGNS

1 Engine
2 Rotating shaft
21 First rotating shaft
22 Second rotating shaft
3 Speed reducer
4 Coupling
5 Driving synchronous pulley
51 First driving synchronous pulley
52 Second driving synchronous pulley
6 Driven synchronous pulley
7 Synchronous belt
71 First synchronous belt
72 Second synchronous belt
8 One-way clutch
81 First one-way clutch
82 First one-way clutch
9 Bearing
91 First bearing member
92 Second bearing
10 Fixed frame
101 First fixed frame
102 Second fixed frame
11 Bearing piece
12 Engine support
13 First engine
14 Second engine

### DETAILED DESCRIPTION

### First Embodiment

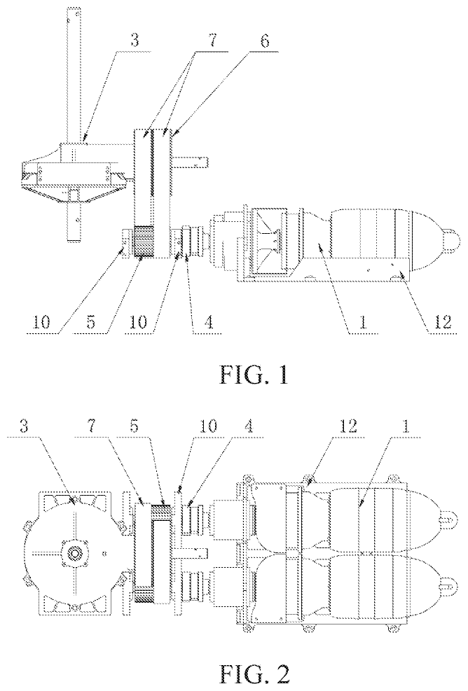

This embodiment provides a power apparatus, and as illustrated in FIG. 1 to FIG. 3, the power apparatus includes an engine 1, a rotating shaft 2, a speed reducer 3 and a coupling 4.

Two engines 1 are provided, and the two engines 1 are symmetrically arranged side by side. The two engines 1 are detachably mounted on an engine support 12. In one embodiment, the two engines 1 can be fixed on the engine support 12 by using screws, facilitating installation and dismounting of the engines 1. In this embodiment, a slide rail (not shown in the figure) may be arranged on the engine support 12, and the above two engines 1 are slidably arranged on the slide rail. When the engines 1 are installed, the engines 1 can be installed at correct positions through the slide rail, and then the engines 1 are fixedly installed on the engine support 12 by using the screws. When the engines 1 are dismounted, the engines 1 can be conveniently and quickly removed by using the slide rail, thus improving a dismounting efficiency. In addition, the two engines 1 in this embodiment are symmetrically arranged side by side, thus effectively reducing a volume of an unmanned helicopter.

In this embodiment, the engine 1 is a turbine shaft engine, and the turbine shaft engine has the characteristics of light weight, small volume, and small vibration. Moreover, by providing two turbine shaft engines, when one of the engines 1 fails, the unmanned helicopter can safely land by using the other engine 1.

In this embodiment, a side face of each engine 1 facing away from the other engine 1 is provided with an exhaust port (not shown in the figure). By symmetrically arranging exhaust ports of the two engines 1, a force generated due to venting can be counteracted, and therefore a normal operation of the unmanned helicopter will not be affected.

An output end of each engine 1 is connected to the coupling 4, and the coupling 4 is connected to the rotating shaft 2. The engine 1 can better drive the rotating shaft 2 to rotate through the coupling 4. In this embodiment, the coupling 4 is a detachable elastic coupling. The detachable elastic coupling has the characteristics of light weight and good performance, and can ensure reliable drive. Moreover, by providing the detachable elastic coupling, the dismounting and installation of the engine 1 can be faster and simpler.

In this embodiment, the rotating shaft 2 and the speed reducer 3 are connected through a synchronous belt 7. In one embodiment, the rotating shaft 2 is provided with a driving synchronous pulley 5 which rotates along with the rotating shaft 2, an output end of the speed reducer 3 is provided with a driven synchronous pulley 6, and two driving synchronous pulleys 5 on the rotating shaft 2 are connected to the driven synchronous pulley 6 separately through the synchronous belts 7. The driving synchronous pulleys 5 rotate along with the rotating shaft 2, such that the driving synchronous pulleys 5 can drive the speed reducer 3 to rotate, thus outputting power. In this embodiment, positions of the two driving synchronous pulleys 5 on the rotating shaft 2 are arranged back and forth in an axial direction, so as to ensure that no interference contact occurs between the two synchronous belts 7.

In this embodiment, a one-way clutch 8 is arranged between the rotating shaft 2 and the driving synchronous pulley 5, that is, the rotating shaft 2 drives the one-way clutch 8 to rotate such that the one-way clutch 8 drives the driving synchronous pulley 5 to rotate. By providing the one-way clutch 8, it can be ensured that the driving synchronous pulley 5 rotates in only one direction, and the engine 1 can also be prevented from being damaged by an overrunning state of the one-way clutch 8.

In this embodiment, bearing members 9 are arranged on a first side of the one-way clutch 8, and two bearing members 9 are sleeved on the rotating shaft 2 and located between the rotating shaft 2 and the driving synchronous pulley 5. By providing the bearing members 9, safety for using the one-way clutch 8 can be improved, and when the one-way clutch 8 is in the overrunning state, the two bearing members 9 can bear radial loads. In this embodiment, the bearing member 9 is a deep groove ball bearing.

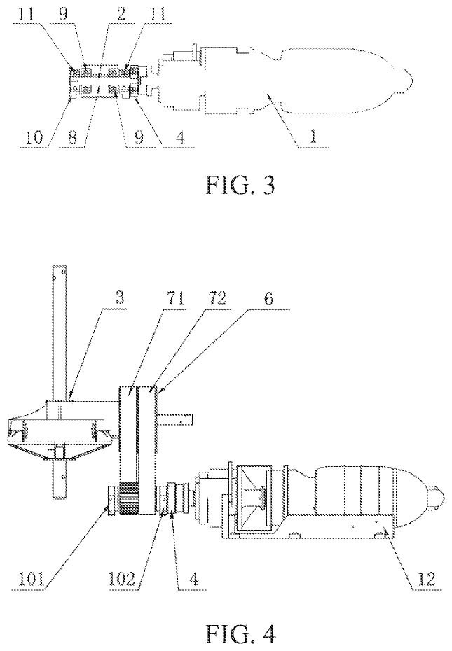

Referring to FIG. 1 and FIG. 3, in this embodiment, two ends of the rotating shaft 2 are each provided with a fixed frame 10, where one fixed frame 10 is arranged on a first end of the rotating shaft 2 which is not connected to the coupling 4, and the other fixed frame 10 is arranged on a second end of the rotating shaft 2 facing towards the coupling 4; and each of the fixed frames 10 is provided with a bearing piece 11, and the two ends of the rotating shaft 2 pass through the hearing piece 11. By providing the bearing piece 11, smooth rotation of the rotating shaft 2 can be ensured. In this embodiment, the bearing piece 11 is a deep groove ball bearing.

In this embodiment, the speed reducer 3 is provided with a bevel drive pinion and a driven bevel gear wheel that are meshed with each other, where a shaft of the bevel drive pinion is connected to the driven synchronous pulley 6 through a flat key, and the driven bevel gear is connected to an output shaft of the speed reducer 3 through a spline.

In this embodiment, through the above-mentioned structure configuration, both the two engines 1 can drive the unmanned helicopter, and when one engine 1 fails, the other engine 1 can still be used, thereby avoiding the damage of the unmanned helicopter caused by the failure of the engine 1 when a single engine 1 drives the unmanned helicopter. Moreover, the exhaust ports of the two engines 1 are arranged symmetrically, such that the force generated due to venting can be counteracted, and therefore the normal operation of the unmanned helicopter will not be affected.

This embodiment further provides an unmanned helicopter including the above-mentioned power apparatus. By providing the above-mentioned power apparatus, the unmanned helicopter can be better driven to operate, and a problem that the unmanned helicopter is damaged due to the failure of the engine when the single engine drives the unmanned helicopter can be avoided.

### Second Embodiment

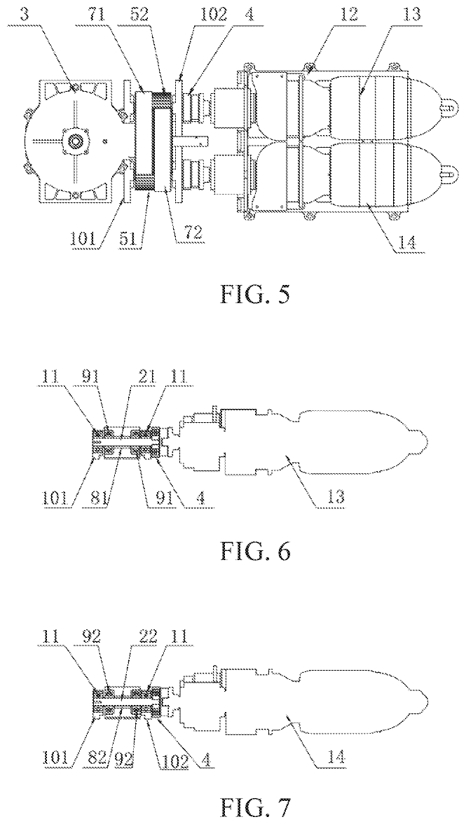

This embodiment provides a power apparatus, and as illustrated in FIG. 4 to FIG. 7, the power apparatus includes: a first engine 13 and a second engine 14 symmetrically arranged side by side; a first rotating shaft 21 connected to an output end of the first engine 13; a second rotating shaft 22 connected to an output end of the second engine 14; and a speed reducer 3 connected to the first rotating shaft 21 and the second rotating shaft 22, where a side face of the first engine 13 facing away from the second engine 14 and a side face of the second engine facing away from the first engine are each provided with an exhaust port.

In one embodiment, the power apparatus further includes a coupling 4 connecting the output end of the first engine 13 to the first rotating shaft 21, and a coupling 4 connecting the second engine 14 to the second rotating shaft 22.

In one embodiment, the power apparatus further includes a first driving synchronous pulley 51 arranged on the first rotating shaft, a second driving synchronous pulley 52 arranged on the second rotating shaft 22, a driven synchronous pulley 6 arranged on an input end of the speed reducer 3, a first synchronous belt 71 connecting the first driving synchronous pulley 51 and the driven synchronous pulley 6, and a second synchronous belt 72 connecting the second driving synchronous pulley 52 and the driven synchronous pulley 6.

In one embodiment, the power apparatus further includes a first one-way clutch 81 arranged between the first rotating shaft 21 and the first driving synchronous pulley 51, and a second one-way clutch 82 arranged between the second rotating shaft 22 and the second driving synchronous pulley 52.

In one embodiment, the power apparatus further includes two first bearing members 91 arranged between the first rotating shaft 21 and the first driving synchronous pulley 51 and two second bearing members 92 arranged between the second rotating shaft 22 and the second driving synchronous pulley 52. The two first bearing members 91 are arranged on two sides of the first one-way clutch 81 respectively, and the two second bearing members 92 are arranged on two sides of the second one-way clutch 82 respectively.

In one embodiment, the power apparatus further includes a first fixed frame 101 and a second fixed frame 102. A first end of the first rotating shaft 21 and a first end of the second rotating shaft 22 are each rotatably connected to the first fixed frame 101, and a second end of the first rotating shaft 21 and a second end of the second rotating shaft 22 are each rotatably connected to the second fixed frame 102.

In one embodiment, the power apparatus further includes a bearing piece 11, where bearing pieces 11 are arranged between the first rotating shaft 21 and the first fixed frame 101, between the first rotating shaft 21 and the second fixed frame 102, between the second rotating shaft 22 and the first fixed frame 101, and between the second rotating shaft 22 and the second fixed frame 102.

In one embodiment, the power apparatus further includes an engine support 12, where both the first engine 13 and the second engine 14 are detachably mounted on the engine support 12.

The coupling 4 is an elastic coupling.

This embodiment further provides an unmanned helicopter including the above-mentioned power apparatus.

1. A power apparatus, comprising:
a first engine and a second engine, symmetrically arranged side by side;
a first rotating shaft, connected to an output end of the first engine;
a second rotating shaft, connected to an output end of the second engine; and
a speed reducer, connected to the first rotating shaft and the second rotating shaft, wherein a side face of the first engine facing away from the second engine and a side face of the second engine facing away from the first engine are each provided with an exhaust port.

2. The power apparatus of claim 1, further comprising:
a coupling, connecting the output end of the first engine to the first rotating shaft; and
a coupling, connecting the second engine to the second rotating shaft.

3. The power apparatus of claim 1, further comprising:
a first driving synchronous pulley, arranged on the first rotating shaft;
a second driving synchronous pulley, arranged on the second rotating shaft;
a driven synchronous pulley, arranged at an input end of the speed reducer;
a first synchronous belt, connecting the first driving synchronous pulley to the driven synchronous pulley; and
a second synchronous belt, connecting the second driving synchronous pulley to the driven synchronous pulley.

4. The power apparatus of claim 3, further comprising:
a first one-way clutch, arranged between the first rotating shaft and the first driving synchronous pulley; and
a second one-way clutch, arranged between the second rotating shaft and the second driving synchronous pulley.

5. The power apparatus of claim 4, further comprising:
two first bearing members, arranged between the first rotating shaft and the first driving synchronous pulley; and
two second bearing members, arranged between the second rotating shaft and the second driving synchronous pulley;
wherein the two first bearing members are respectively arranged on two sides of the first one-way clutch, and the two second bearing members are respectively arranged on two sides of the second one-way clutch.

6. The power apparatus of claim 1, further comprising:
a first fixed frame; and
a second fixed frame;
wherein a first end of the first rotating shaft and a first end of the second rotating shaft are both rotatably connected to the first fixed frame, and a second end of the first rotating shaft and a second end of the second rotating shaft are both rotatably connected to the second fixed frame.

7. The power apparatus of claim 6, further comprising:
a bearing piece, arranged between the first rotating shaft and the first fixed frame;
a bearing piece, arranged between the first rotating shaft and the second fixed frame,
a bearing piece, arranged between the second rotating shaft and the first fixed frame, and
a bearing piece, arranged between the second rotating shaft and the second fixed frame.

8. The power apparatus of claim 1, further comprising an engine support, wherein both the first engine and the second engine are detachably mounted on the engine support.

9. The power apparatus of claim 2, wherein the coupling is an elastic coupling.

10. An unmanned helicopter comprising a power apparatus, the power apparatus comprising:
a first engine and a second engine, symmetrically arranged side by side;
a first rotating shaft, connected to an output end of the first engine;
a second rotating shaft, connected to an output end of the second engine; and
a speed reducer, connected to the first rotating shaft and the second rotating shaft, wherein a side face of the first engine facing away from the second engine and a side face of the second engine facing away from the first engine are each provided with an exhaust port.

11. The unmanned helicopter of claim 10, further comprising:
a coupling, connecting the output end of the first engine to the first rotating shaft; and
a coupling, connecting the second engine to the second rotating shaft.

12. The unmanned helicopter of claim 10, further comprising:
a first driving synchronous pulley, arranged on the first rotating shaft;
a second driving synchronous pulley, arranged on the second rotating shaft;
a driven synchronous pulley, arranged at an input end of the speed reducer;
a first synchronous belt, connecting the first driving synchronous pulley to the driven synchronous pulley; and
a second synchronous belt, connecting the second driving synchronous pulley to the driven synchronous pulley.

13. The unmanned helicopter of claim 12, further comprising:
a first one-way clutch, arranged between the first rotating shaft and the first driving synchronous pulley; and
a second one-way clutch, arranged between the second rotating shaft and the second driving synchronous pulley.

14. The unmanned helicopter of claim 13, further comprising:
two first bearing members, arranged between the first rotating shaft and the first driving synchronous pulley; and
two second bearing members, arranged between the second rotating shaft and the second driving synchronous pulley;
wherein the two first bearing members are respectively arranged on two sides of the first one-way clutch, and the two second bearing members are respectively arranged on two sides of the second one-way clutch.

15. The unmanned helicopter of claim 10, further comprising:
a first fixed frame; and
a second fixed frame;
wherein a first end of the first rotating shaft and a first end of the second rotating shaft are both rotatably connected to the first fixed frame, and a second end of the first rotating shaft and a second end of the second rotating shaft are both rotatably connected to the second fixed frame.

16. The unmanned helicopter of claim 15, further comprising:
a bearing piece, arranged between the first rotating shaft and the first fixed frame;
a bearing piece, arranged between the first rotating shaft and the second fixed frame,
a bearing piece, arranged between the second rotating shaft and the first fixed frame, and
a bearing piece, arranged between the second rotating shaft and the second fixed frame.

17. The unmanned helicopter of claim 10, further comprising an engine support, wherein both the first engine and the second engine are detachably mounted on the engine support.

18. The unmanned helicopter of claim 11, wherein the coupling is an elastic coupling.
